(19) United States
(12) Patent Application Publication
(10) Pub. No.: US 2025/0222716 A1
(43) Pub. Date: Jul. 10, 2025

(54) HUBLESS WHEEL HAVING AN IMPROVED STRUCTURE

(71) Applicant: DAEWON J&B CO., LTD., Seoul (KR)

(72) Inventor: JaeChul LEE, Seoul (KR)

(73) Assignee: DAEWON J&B CO., LTD., Seoul (KR)

(21) Appl. No.: 18/796,492

(22) Filed: Aug. 7, 2024

(30) Foreign Application Priority Data
Jan. 7, 2024 (KR) 10-2024-0002581

(51) Int. Cl. B60B 19/00

(52) U.S. Cl. CPC B60B 19/00

(57) ABSTRACT

A hubless wheel with an improved structure includes a fixed wheel (110), a rotating wheel (120) disposed outside the fixed wheel (110), and a bearing (130) disposed between the fixed wheel (110) and the rotating wheel (120) and having an inner ring (131) and an outer ring (132). An inner ring seating surface (111a) and an inner ring contact surface (111b) perpendicular thereto are provided on the fixed wheel (110), and an outer ring seating surface (121a) and an outer ring contact surface (121b) perpendicular thereto are provided on the rotating wheel (120).

### TECHNICAL FIELD

The present invention relates to a hubless wheel, and more specifically, to a hubless wheel with an improved structure as compared to the prior art.

### BACKGROUND

A hubless wheel is a wheel that is empty inside without structures such as a hub.

The hubless wheel includes a fixed wheel disposed on the inside and a rotating wheel disposed on the outside.

While a typical wheel has a structure in which all of its parts rotate, in a hubless wheel, the outer rotating wheel and the tire attached to it rotate, and the inner fixed wheel does not rotate.

A bearing is essential between the fixed wheel and the rotating wheel of a hubless wheel to ensure smooth operation of the wheel.

Depending on the structural characteristics of hubless wheels, the bearings placed between the fixed wheel and the rotating wheel are manufactured in relatively large sizes. Therefore, in hubless wheels, bearings are an important factor in determining the weight, assembly ability, and noise characteristics of the wheel.

### SUMMARY

The present invention seeks to provide a hubless wheel with improved assembly and noise characteristics that reduces weight through improvements in bearings and their mounting structures.

The present invention includes a fixed wheel (110); a rotating wheel (120) disposed outside the fixed wheel (110); and a bearing (130) disposed between the fixed wheel (110) and the rotating wheel (120) and having an inner ring (131) and an outer ring (132). The inner ring (131) is formed on the outer circumference of the fixed wheel (110). An inner ring seating surface (111a) and an inner ring contact surface (111b) perpendicular to the inner ring seating surface (111a) are provided on the outer circumference of the fixed wheel (110). An outer ring seating surface (121a) and an outer ring contact surface (121b) perpendicular to the outer ring seating surface (121a) are provided on the inner circumference of the rotating wheel (120). This provides a hubless wheel in which the inner ring contact surface (111b) of the fixed wheel (110) and the outer ring contact surface (121b) of the rotating wheel (120) are arranged to face each other.

In one embodiment, the fixed wheel (110) is provided with a plurality of adhesion member mounting grooves (115) disposed along the outer circumference of the fixed wheel (110) and formed on opposite sides of the inner ring contact surface (111b). The rotating wheel (120) may be provided with a plurality of adhesion member mounting grooves (125) disposed along the inner circumference and formed on opposite sides of the outer ring contact surface (121b).

In one embodiment, the hubless wheel has a plurality of adhesion members (141) fastened to the plurality of adhesion member mounting grooves (115) of the fixed wheel (110) and in close contact with the inner ring (131) of the bearing (130) in the lateral direction. The hubless wheel further has a plurality of adhesion members (151) fastened to the plurality of adhesion member mounting grooves (125) of the rotating wheel (120) and in close contact with the outer ring (132) of the bearing (130) in the lateral direction.

### Advantageous Effects

Since the bearing provided in the hubless wheel of the present invention and its mounting structure are relatively simple, assembly is excellent and the bearing is suitable for reducing the weight of the hubless wheel.

### BRIEF DESCRIPTION OF THE DRAWINGS

FIG. 1 is a diagram showing a hubless wheel (100) according to an embodiment of the present invention.

FIG. 2 is a view viewed from the opposite side of the hubless wheel (100).

FIG. 3 is an exploded view of the hubless wheel (100).

FIGS. 4 and 5 show the bearing (130) provided in the hubless wheel (100) and the inner ring adhesion means (140) and outer ring adhesion means (150) therefor.

FIG. 4 is a view viewed from one side and

FIG. 5 is a view viewed from the opposite side.

FIG. 6 is a diagram showing the fixed wheel (110) provided on the hubless wheel (100).

FIG. 7 is a diagram showing the rotating wheel (120) provided on the hubless wheel (100).

FIGS. 8 to 10 show the cross-sectional structure of the hubless wheel (100).

FIG. 8 shows the parts in an exploded state, and

FIGS. 9 and 10 show opposite sides of the hubless wheel (100).

FIGS. 11A-11D are diagrams showing the assembly process of the hubless wheel (100).

### DETAILED DESCRIPTION

Hereinafter, embodiments of the present invention will be described in more detail with reference to the drawings.

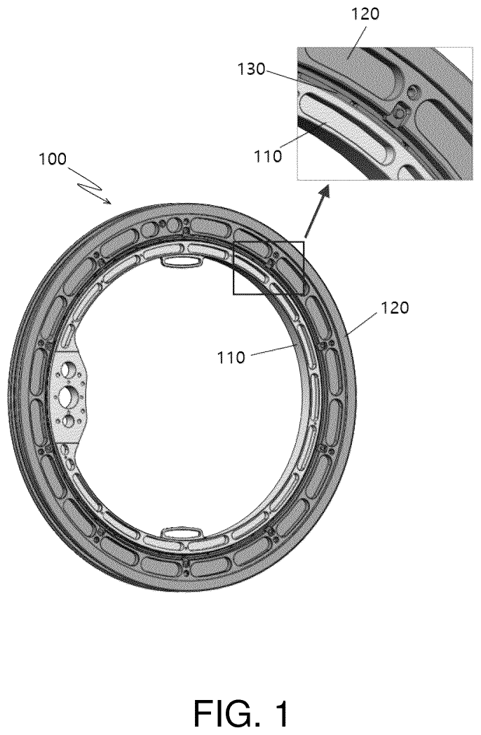

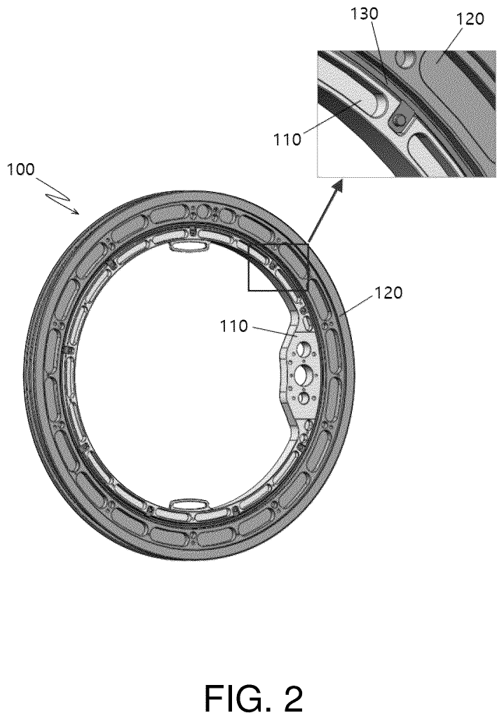

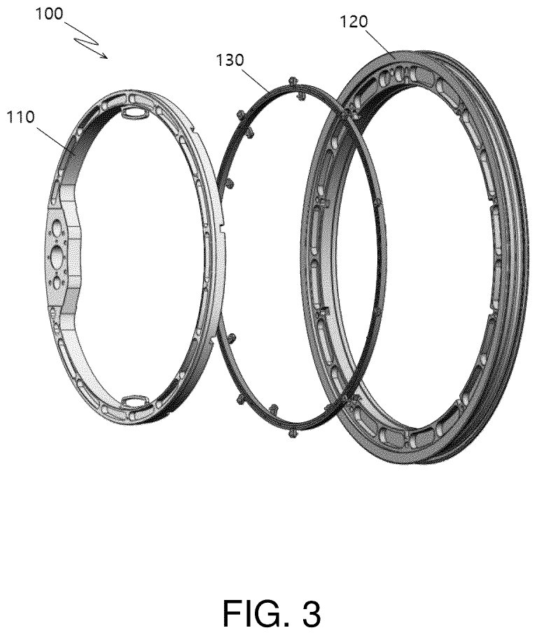

FIG. 1 is a diagram showing a hubless wheel (100) according to an embodiment of the present invention, FIG. 2 is a diagram viewed from the opposite side of the hubless wheel (100), and FIG. 3 is an exploded view of the hubless wheel (100).

Referring to the drawings, the hubless wheel (100) according to an embodiment of the present invention has a hubless structure and can be suitably used for a bicycle. Without being limited thereto, the hubless wheel (100) may also be applied to other types of transportation, such as a three-wheeled bicycle, also referred to as a velomobile.

The hubless wheel (100) includes a fixed wheel (110), a rotating wheel (120), and a bearing (130).

The fixed wheel (110) is a wheel disposed inside the hubless wheel (100) and is fixedly mounted on a vehicle body such as a bicycle body frame. In this way, since the fixed wheel (110) is a fixedly mounted part, it does not rotate during operation.

The rotating wheel (120) is disposed outside the fixed wheel (110). Unlike the fixed wheel (110), the rotating wheel (120) is not fixed to the vehicle body and thus rotates during driving.

The fixed wheel (110) and the rotating wheel (120) are made of metal, preferably aluminum.

The bearing (130) ensures smooth rotation of the rotating wheel (120) by minimizing friction between the fixed wheel (110) and the rotating wheel (120) during operation. The bearing (130) is disposed between the fixed wheel (110) and the rotating wheel (120) and has a circular ring shape.

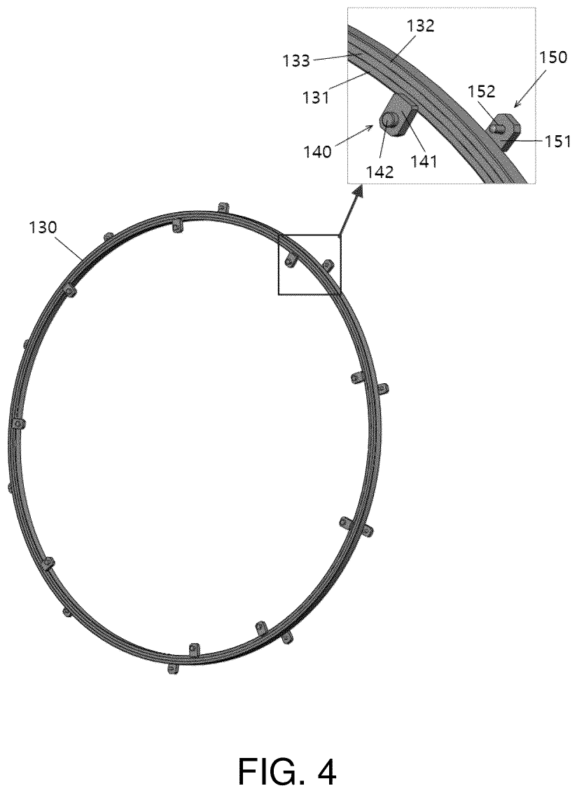

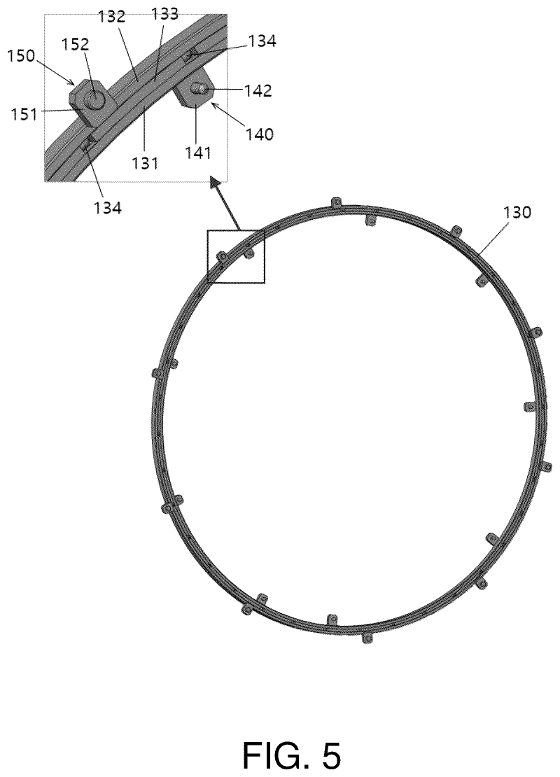

FIGS. 4 and 5 show the bearing (130) provided in the hubless wheel (100) and the inner ring adhesion means (140) and outer ring adhesion means (150) therefor. FIG. 4 is a view viewed from one side and FIG. 5 is a view viewed from the opposite side.

Referring to these drawings, the bearing (130) includes an inner ring (131), an outer ring (132), a middle ring (133), and a plurality of bearing balls (134). The middle ring (133) is disposed between the inner ring (131) and the outer ring (132), and the middle ring (133) holds a plurality of bearing balls (134) such that the plurality of bearing balls (134) are maintained at equal intervals.

As shown in FIGS. 4 and 5, the hubless wheel (100) is provided with a plurality of inner ring adhesion means (140) and a plurality of outer ring adhesion means (150). These adhesion means (140, 150) are for preventing the bearing (130) from moving out of position. The inner ring adhesion means (140) is composed of an adhesion member (141) and a screw (142), and similarly, the outer ring adhesion means (150) is also composed of an adhesion member (151) and a screw (152). The adhesion members (141 and 151) may be manufactured in the form of a square plate with a uniform thickness. The screws (142 and 152) may have hexagonal grooves on their screw heads so that an electric drill can be used to fasten them.

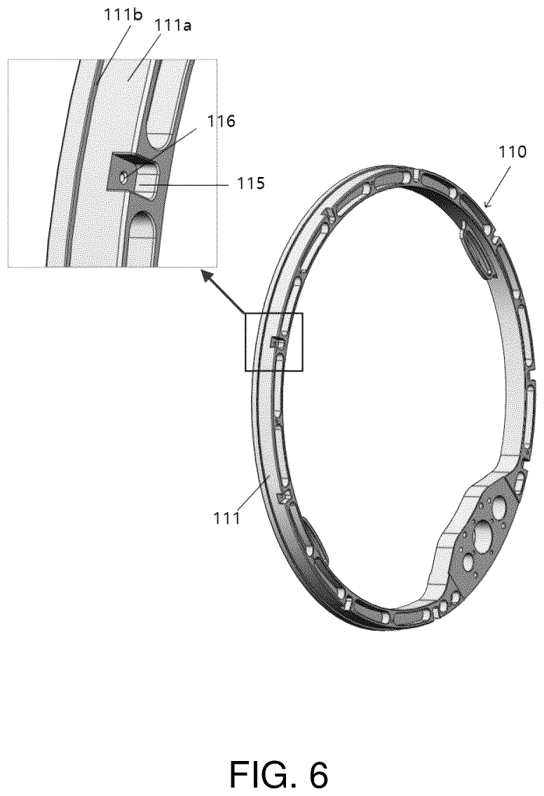

FIG. 6 is a diagram showing the fixed wheel (110) provided on the hubless wheel (100).

The outer perimeter (111) of the fixed wheel (110) has a stepped structure. Therefore, the outer circumference of the fixed wheel (110) provides an inner ring seating surface (111a) and an inner ring contact surface (111b) perpendicular to the inner ring seating surface (111a). In the process of assembling the hubless wheel (100), the inner ring (131) of the bearing (130) is seated on the inner ring seating surface (111a) of the fixed wheel (110), and one side of the inner ring (131) is in contact with the inner ring contact surface (111b) of the fixed wheel (110).

The fixed wheel (110) is provided with a plurality of adhesion member mounting grooves (115) arranged along its outer circumference. As shown in FIG. 6, the adhesion member mounting groove (115) is formed to be concave at a predetermined depth in the thickness direction on one side of the fixed wheel (110) and is formed on the opposite side of the inner ring contact surface (111b). A screw fastening hole (116) formed in the thickness direction of the fixed wheel (110) is provided on the bottom of the adhesion member mounting groove (115).

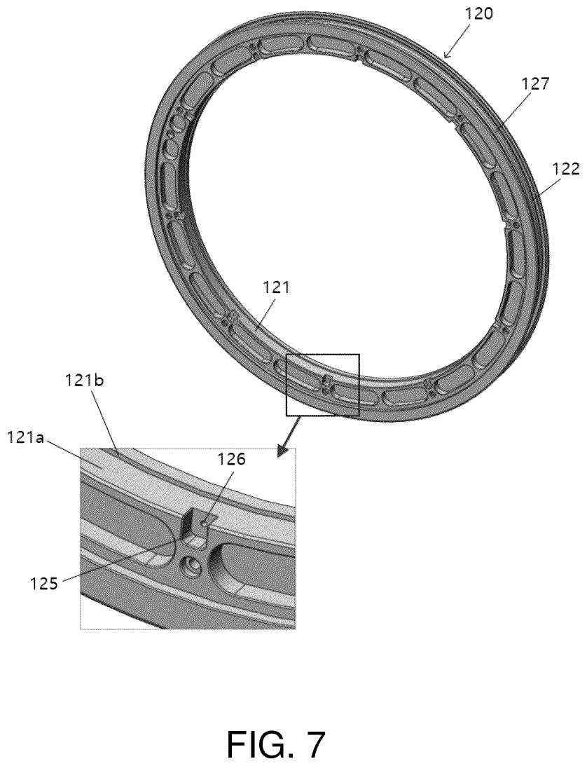

FIG. 7 is a diagram showing the rotating wheel (120) provided on the hubless wheel (100).

The inner circumference (121) of the rotating wheel (120) has a stepped structure. Therefore, the inner circumference of the rotating wheel (120) provides an outer ring seating surface (121a) and an outer ring contact surface (121b) perpendicular to the outer ring seating surface (121a). In the process of assembling the hubless wheel (100), the outer ring (132) of the bearing (130) is seated on the outer ring seating surface (121a) of the rotating wheel (120), and one side of the outer ring (132) is in contact with the outer ring contact surface (121b) of the rotating wheel (120).

The rotating wheel (120) is provided with a plurality of adhesion member mounting grooves (125) arranged along its inner circumference. As shown in FIG. 7, the adhesion member mounting groove (125) is formed to be concave at a predetermined depth in the thickness direction on one side of the rotating wheel (120) and is formed on the opposite side of the outer ring contact surface (121b). A screw fastening hole (126) formed in the thickness direction of the rotating wheel (120) is provided on the bottom of the adhesion member mounting groove (125).

The rotating wheel (120) is provided with a tire mounting groove (127) formed along its outer perimeter (122). A tire (not shown) made of an elastic material (e.g., rubber) is mounted in this tire mounting groove (127).

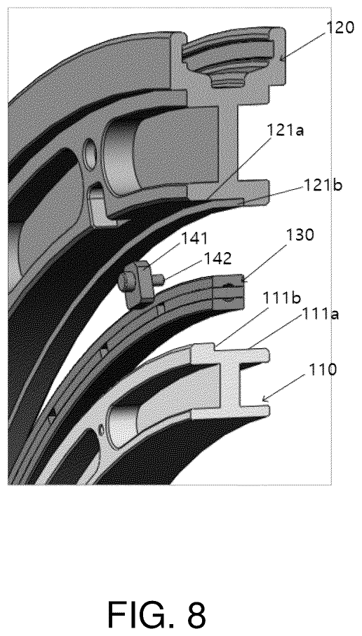

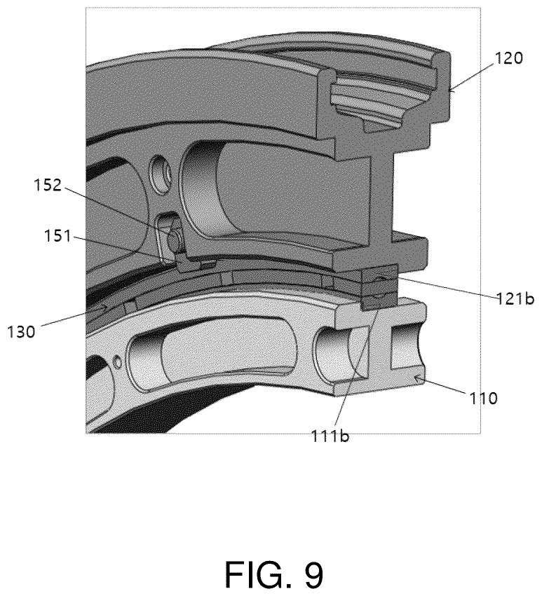

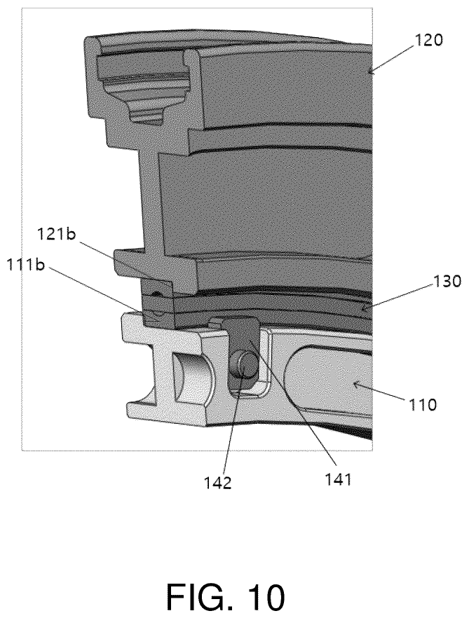

FIGS. 8 to 10 show the cross-sectional structure of the hubless wheel (100). FIG. 8 shows the parts in an exploded state, and FIGS. 9 and 10 show opposite sides of the hubless wheel (100).

Referring to FIGS. 8 to 10, the inner ring contact surface (111b) of the fixed wheel (110) and the outer ring contact surface (121b) of the rotating wheel (120) are arranged to face each other. Therefore, when the hubless wheel (100) is assembled, both sides of the bearing (130) are in contact with the two contact surfaces (111b and 121b), so that the lateral movement of the bearing (130) is suppressed.

Referring to FIGS. 9 and 10, in a state in which the hubless wheel (100) is assembled, an adhesion member (141) is laterally adhered to the inner ring (131) of the bearing (130) and an adhesion member (151) is laterally adhered to the outer ring (132) of the bearing (130). Due to the action of these adhesion members (141 and 151), the lateral movement of the bearing (130) is more completely suppressed.

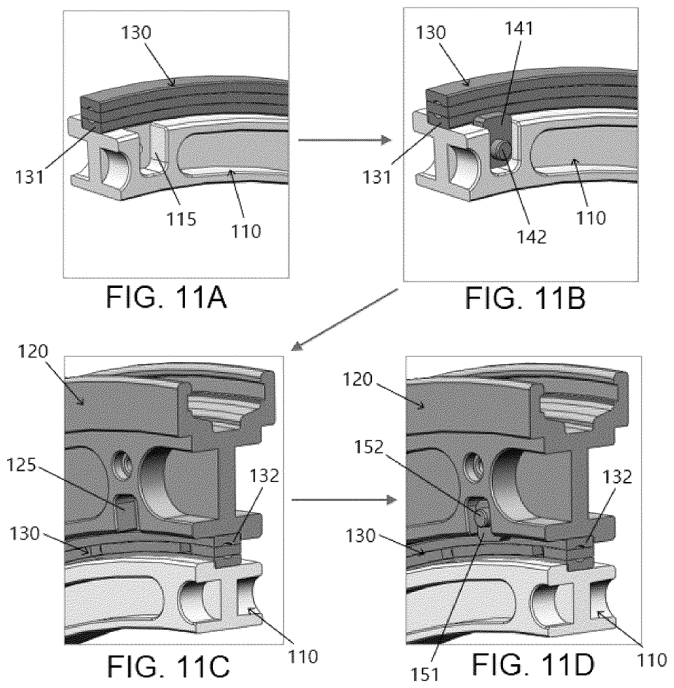

FIGS. 11A-11D are diagrams showing the assembly process of the hubless wheel (100).

First, the fixed wheel (110) and the bearing (130) are coupled as shown in FIG. 11A. In this process, hydraulic press equipment may be used to strongly push the fixed wheel (110) or bearing (130) in the lateral direction. As a result of this process, the inner ring (131) of the bearing (130) is tightly coupled to the fixed wheel (110).

Next, as shown in FIG. 11B, a plurality of adhesion members (141) are fastened to the fixed wheel (110). As described above, a plurality of adhesion member mounting grooves (115) are concavely formed along the outer circumference of the fixed wheel (110), and the plurality of adhesion members (141) are fastened to the plurality of adhesion member mounting grooves (115). This tightening process can be done quickly using a power drill. The plurality of adhesion members (141) fastened in this way are in close contact with the inner ring (131) of the bearing (130), thereby preventing the bearing (130) from moving out of position, and ensuring that the state of the inner ring (131) being tightly coupled to the fixed wheel (110) remains stable.

Next, the rotating wheel (120) and the bearing (130) are combined as shown in FIG. 11C. In this process, hydraulic press equipment may be used to strongly push the rotating wheel (120) or bearing (130) in the lateral direction. As a result of performing this process, the outer ring (132) of the bearing (130) is tightly coupled to the rotating wheel (120).

Finally, as shown in FIG. 11D, a plurality of adhesion members (151) are fastened to the rotating wheel (120). As described above, a plurality of adhesion member mounting grooves (125) are concavely formed along the inner circumference of the rotating wheel (120), and the plurality of adhesion member (151) are fastened to the plurality of adhesion member mounting groves (125). This tightening process can be done quickly using an electric drill. The plurality of adhesion members (151) fastened in this way are in close contact with the outer ring (132) of the bearing (130), thereby preventing the bearing (130) from moving out of position, and ensuring that the state of the outer ring (132) being tightly coupled to the rotating wheel (120) remains stable.

### REFERENCE NUMBERS

100: Hubless wheel
110: Fixed wheel
111: Outer perimeter
111a: Inner ring seating surface
111b: Inner ring contact surface
115: Adhesion member mounting groove
116: Screw fastening hole
120: Rotating wheel
121: Inner circumference
121a: Outer ring seating surface
121b: Outer ring contact surface
122: Outer perimeter
125: Adhesion member mounting groove
126: Screw fastening hole
127: Tire mounting groove
130: Bearing
131: Inner ring
132: Outer ring
133: Middle ring
134: Bearing ball
140: Inner ring adhesion means
141: Adhesion member
142: Screw
150: Outer ring adhesion means
151: Adhesion member
152: Screw

What is claimed is:

1. A hubless wheel, comprising:
a fixed wheel (110);
a rotating wheel (120) disposed outside the fixed wheel (110); and
a bearing (130) disposed between the fixed wheel (110) and the rotating wheel (120) and having an inner ring (131) and an outer ring (132),
wherein the fixed wheel (110) includes an inner ring seating surface (111a) and an inner ring contact surface (111b) on an outer circumference of the fixed wheel (110), the inner ring contact surface (111b) being perpendicular to the inner ring seating surface (111a), and
wherein the rotating wheel (120) includes an outer ring seating surface (121a) and an outer ring contact surface (121b) on an inner circumference of the rotating wheel (120), the outer ring contact surface (121b) being perpendicular to the outer ring seating surface (121a).

2. The hubless wheel of claim 1, wherein:
the fixed wheel (110) is provided with a plurality of adhesion member mounting grooves (115) disposed along the outer circumference of the fixed wheel (110) and formed opposite to the inner ring contact surface (111b); and
the rotating wheel (120) is provided with a plurality of adhesion member mounting grooves (125) disposed along the inner circumference of the rotating wheel (120) and formed opposite to the outer ring contact surface (121b).

3. The hubless wheel of claim 2, further comprising:
a plurality of adhesion members (141) which are fastened to the plurality of adhesion member mounting grooves (115) of the fixed wheel (110) and are laterally in close contact with the inner ring (131) of the bearing (130); and
a plurality of adhesion members (151) which are fastened to the plurality of adhesion member mounting grooves (125) of the rotating wheel (120) and are laterally in close contact with the outer ring (132) of the bearing (130).
